(19) United States
(12) Patent Application Publication
(10) Pub. No.: US 2006/0207018 A1
(43) Pub. Date: Sep. 21, 2006

(54) Fan assembly for a bath therapy apparatus

(76) Inventors: Mordechai Lev, West Blomfield, MI (US); Stephen Chung, Taipei (TW)

Correspondence Address: BROOKS KUSHMAN P.C., 1000 TOWN CENTER, TWENTY-SECOND FLOOR, SOUTHFIELD, MI, 48075, US

(21) Appl. No.: 11/084,303

(22) Filed: Mar. 18, 2005

(51) Int. Cl. A47K 3/022; A61H 35/00; E03C 1/00

(52) U.S. Cl. 4/622

(57) ABSTRACT

A bath therapy apparatus is disclosed having a sound dampened fan assembly for forcing air into a bath chamber for providing a bubbling massage effect. A sound level measurement of the fan assembly under predefined conditions is less than that of the bubbling massage effect. Thus, output sound level of the apparatus in operation is reduced without affecting the therapeutic effects of the bath apparatus.

### BACKGROUND OF THE INVENTION

1. Field of the Invention

This invention relates to an apparatus for bathing body parts, such as the feet or hands.

2. Background Art

Most people experience foot problems at some time in their lives. This is not surprising, considering that many people are employed in jobs that require them to be on their feet all day. In fact, even an average day of walking can exert force equal to several hundred tons of pressure on the feet.

In an attempt to alleviate a variety of podiatric problems, bathing of the feet has become a recognized therapeutic method. For example, soaking soothes the feet and aids in recovery from fatigue. Bathing of the feet also stimulates the circulation of blood therethrough, which results in increased metabolism and excretion. In addition, footbathing facilitates the removal of painful growths such as calluses, bunions, and corns.

Many types of footbaths have been utilized as therapeutic devices for the feet. Typically, footbaths provide heated water for which the temperature is maintained via electrical means. In addition, current footbaths often provide massage to the feet through vibration of the footbath. Vibratory massage enhances the therapeutic results achieved with soaking alone by further increasing circulation, as well as relaxing and massaging the muscles.

In addition to heat and vibratory massage, some footbaths are also capable of creating air bubbles in the water contained in the bath chamber. Contact of the air bubbles with a user's feet provides an additional type of massage therapy.

These footbaths often employ a fan for pumping air into the water contained in the bath chamber. The fan often includes a generally cylindrical volute shroud with an impeller therein. A plurality of radial infeed apertures are provided between a motor that drives the fan and the shroud, and the infeed apertures are generally adjacent to a central region of the fan for permitting air to flow into the shroud. The shroud includes a pair of tangential outfeed ports for forcing air out of the shroud. Tubing is connected to each outfeed port generally perpendicular to the tangential direction of the port. Although a pleasant massage effect is provided, a relatively loud sound is provided by the fan operation.

For example, one prior art footbath with the fan in operation provides a sound level of sixty decibels measured at one meter in an open room with a background sound level of forty-four decibels. Another prior art footbath measured under the same conditions provides a sound level output of sixty-four decibels.

Of course, not all output sound levels require dampening. For example, to provide a desired bubbling massage effect, a resultant bubbling sound level may be necessary. Accordingly, a goal of the present invention is to provide a footbath with both adequate therapy effects and with a lessened output sound level for improving overall comfort to the user.

### SUMMARY OF THE INVENTION

Accordingly, an aspect of the present invention is to provide a footbath with an output sound level that is less than prior art footbaths.

Another aspect of the present invention is to provide a footbath having a bath chamber for retaining water. A fan is mounted within a housing of the footbath for providing air through a plurality of egress apertures formed within a platform of the bath chamber to thereby provide a bubbling massage effect to an underside of a body part within the bath chamber. A sound level measurement of the fan in operation under defined testing conditions is less than a sound level measurement of the bubbling massage effect measured under the same testing conditions.

Another aspect of the present invention is wherein the fan includes a motor mount bracket mounted to the housing, and a motor mounted to the bracket. The motor includes a rotary output shaft for driving an impeller. The impeller has a series of toric impeller blades. A volute shroud is mounted to the bracket for enclosing the impeller. The shroud includes an axial infeed port and a tangential outfeed port. Rotation of the motor drives the impeller within the shroud and forces air through the infeed port into the shroud and out of the shroud through the tangential outfeed port. The forced air is introduced into the basin through the egress apertures for providing the bubbling massage effect.

The above aspects and other aspects, objects, features, and advantages of the present invention are readily apparent from the following detailed description of embodiments of the invention when taken in connection with the accompanying drawings.

### BRIEF DESCRIPTION OF THE DRAWINGS

FIG. 1 is a perspective view of a bath apparatus constructed in accordance with the present invention;

FIG. 2 is a top plan view of the bath apparatus of FIG. 1;

FIG. 3 is a side elevational view of the bath apparatus of FIG. 1, wherein the wall structure is partially cut away to show a user's foot engaging the contact portion;

FIG. 4 is a fragmentary view of a pump, heating, vibration, and massage assemblies located on the underside of a bath chamber of the bath apparatus of FIG. 1;

FIG. 5 is a side perspective view of the pump assembly of FIG. 4;

FIG. 6 is an enlarged top plan view of the pump assembly of FIG. 4, illustrated with a shroud removed; and

FIG. 7 is a side elevational, partial section view of the pump assembly of FIG. 4.

### DETAILED DESCRIPTION OF EMBODIMENTS OF THE INVENTION

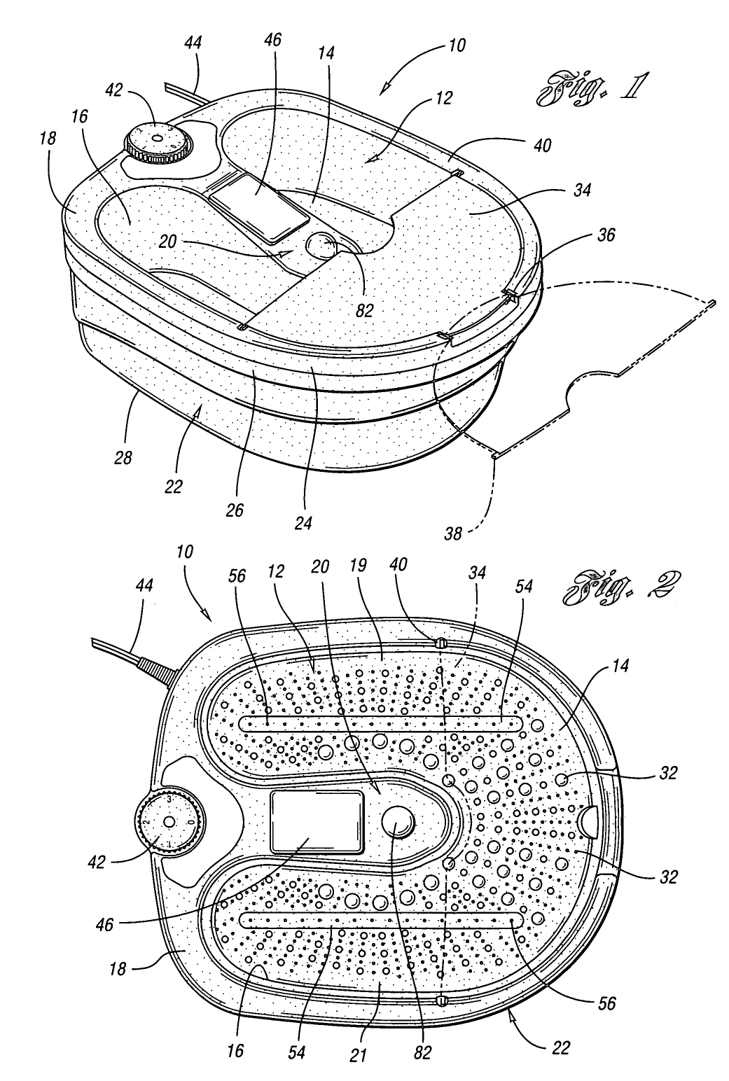

Referring first to FIGS. 1-4, a bath apparatus constructed according to the present invention is depicted and designated generally by reference numeral 10. Bath apparatus 10 can be used to provide heat, massage, bubbles, and combinations thereof to body parts, such as the feet. Bath apparatus 10 is preferably constructed from a plastic material so as to be lightweight and portable, as well as durable, leakproof, and corrosion resistant. Although bath apparatus 10 is illustrated and described herein as being particularly adaptable for use as a footbath, it is understood that bath apparatus 10 of the present invention may be used for bathing other body parts, such as the hands.

With reference to FIG. 1, bath apparatus 10 includes a bath chamber 12 for containing fluid, such as water, and for receiving the body part, such as the foot, therein. Bath chamber 12 includes a floor or bottom surface 14 and a wall structure 16 extending upwardly therefrom. Wall structure 16 terminates in an upper surface 18 that includes a contact portion 20 adapted to be exposed when water is contained in bath chamber 12. Bottom surface 14 can be generally parallel to a supporting surface on which bath apparatus 10 is placed or, alternatively, bottom surface 14 could be slanted downwardly toward the user.

Bath chamber 12 is of a length and width to accommodate the feet of an adult user, such that sufficient space is provided to permit the user to readily insert and remove his/her foot and to allow the foot to be moved about slightly while in position within bath chamber 12. As shown in FIGS. 1 and 2, bath chamber 12 is generally U-shaped and contact portion 20 is generally peninsular and centrally disposed within bath chamber 12. With this configuration, a user's feet are received on either side of peninsular contact portion 20, also denoted as first side 19 and second side 21 of bottom surface 14, wherein the feet are spaced apart sufficiently to provide comfortable placement. For use, bath chamber 12 is filled with water such that a user, preferably seated, submerses his/her feet up to approximately the height of the ankles. A user can then easily remove his/her foot for placement on contact portion 20 for targeted therapy as described below. Of course, it is understood that contact portion 20 can have any location on bath apparatus 10 which remains uncovered by water and is accessible to the user.

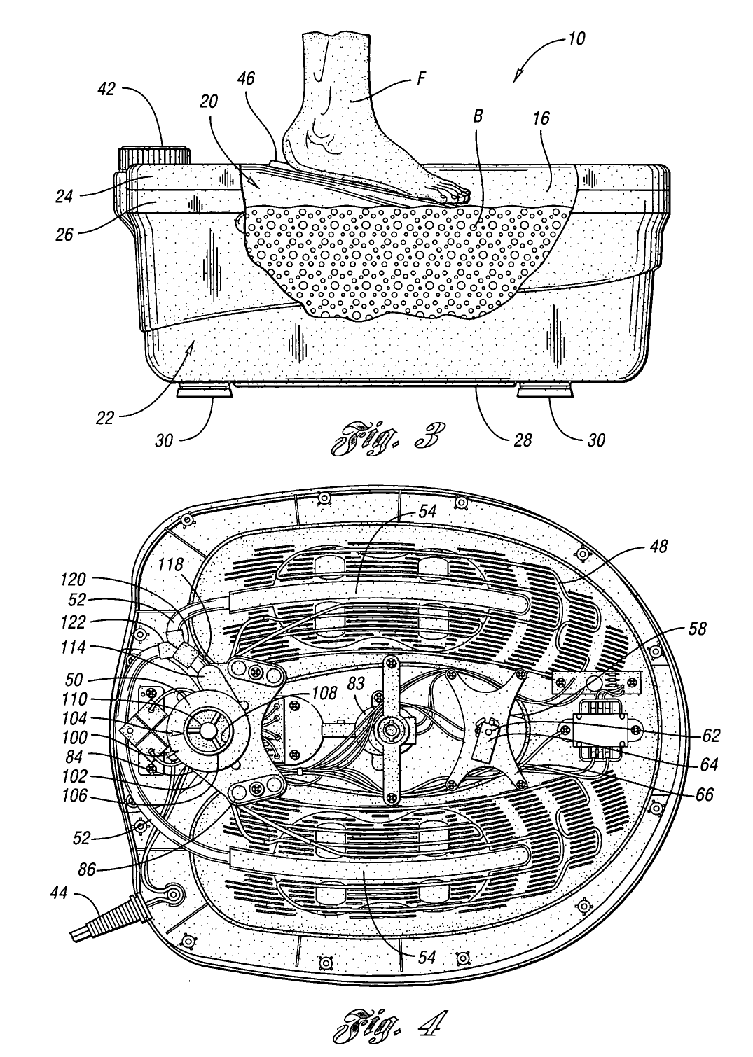

An outer housing 22 is provided to encase bath chamber 12, wherein outer housing 22 is spaced from bath chamber 12 to provide a location for housing the various mechanical/electrical assemblies of bath apparatus 10, as described below with reference to FIG. 4. As best shown in FIGS. 1 and 3, upper surface 18 of bath chamber 12 includes a downwardly extending flange 24 which aligns with an upwardly extending flange 26 of outer housing 22. Flanges 24, 26 are secured together by screws (not shown) to fix bath chamber 12 in position with respect to outer housing 22. A base 28 of outer housing 22 is preferably provided with feet 30 constructed from a material such as rubber to resist movement of bath apparatus 10 along a supporting surface.

Referring again to the top plan view of FIG. 2, bottom surface 14 of bath chamber 12 preferably includes a plurality of raised nodes 32 which can be of varying sizes. Nodes 32 function to massage the feet upon contact, and also allow water and heat to flow under the feet to improve blood circulation. As shown in FIGS. 1 and 2, bath apparatus 10 further includes a lid 34 adapted to be attached to wall structure 16 to at least partially cover bath chamber 12. As shown, lid 34 is attached to wall structure 16 by a hinge 36, and includes tabs 38 that are securely received in corresponding openings 40 provided on wall structure 16. Therefore, as shown in FIG. 1, lid 34 can be positioned to partially cover bath chamber 12 to prevent any accidental splashing of water, or lid 34 can be rotated away from bath chamber 12 about hinge 36 for ease of inserting and removing the feet and filling bath chamber 12 with water.

Lid 34 is preferably constructed from a plastic material, and is sufficiently rigid so that it can be used as a foot rest when only one foot is submersed within bath chamber 12. Alternatively, as disclosed in Ferber et al. U.S. Pat. No. 6,725,471 of same assignee, titled Bath Apparatus, a lid can simply snap fit over wall structure 16 to be completely removable. The Ferber et al. U.S. Pat. No. 6,725,471 patent is incorporated in its entirety by reference herein. Kaufman et al. U.S. Pat. No. 6,568,000 B1 of same assignee, titled Bath Apparatus with Therapy Centers, also discloses advantageous therapeutic effects provided within a bath apparatus, which may be incorporated with the features of the present invention. Accordingly, the Kaufman et al. U.S. Pat. No. 6,568,000 patent is incorporated in its entirety by reference herein.

Referring again to FIGS. 1-3, a selector 42 is located on upper surface 18 of bath chamber 12, wherein selector 42 is rotatable by a user to selectively provide various combinations of heat, massage, and bubbles to the feet. Wiring interconnects selector 42 with each of the mechanical/electrical assemblies described below which are then powered via connection of a standard power cord 44 to any 110 V AC outlet. In a preferred embodiment, selector 42 can be set to provide three different combinations of bath functions: 1) vibration massage, chamber heat, and targeted infrared heat; 2) vibration massage, bubbles, chamber heat, and targeted infrared heat; and 3) bubbles and chamber heat. However, it is understood that other combinations are fully contemplated in accordance with the present invention.

With reference to FIGS. 1-4, the several mechanical/electrical assemblies of bath apparatus 10 of the present invention will now be described. Each of the following assemblies is housed in the space between bath chamber 12 and outer housing 22 and is selectively powered as determined by the setting of selector 42. First, a heating member 46 is provided on contact portion 20 for providing heat to the foot surface when the foot F is placed on contact portion 20. Advantageously, heating member 46 provides the capability of focusing heat on the specific region of the foot desired by the user. According to a preferred embodiment of the present invention, heating member 46 uses infrared rays. Infrared rays allow heat to penetrate deep underneath the surface of the skin, causing the pores of the skin to be opened and promoting metabolism and excretion of the body through increased blood circulation. The applied pressure of the foot on heating member 46 can be adjusted by the user for optimum comfort. Although the surface of heating member 46 is shown herein to be generally flat, heating member 46 could have any contour suitable for contact with a user's foot.

In addition to heating member 46, a heater is provided in communication with bath chamber 12. As best shown in FIG. 4, the heater preferably includes a rope heating element 48 secured underneath bottom surface 14 of bath chamber 12. Upon receiving electrical power, as determined by selector 42, rope heating element 48 is operable to conduct heat to the water contained within bath chamber 12. The heated water maintained by rope heating element 48 relieves tired muscles and promotes circulation of the blood. Rope heating element 48 is positioned to wind back and forth to substantially cover bath chamber bottom surface 14. Rope heating element 48 preferably includes insulated conducting wires, wherein the conductive materials are capable of transmitting heat to bath chamber bottom surface 14 without generating temperatures that exceed the melting point of the plastic material used to construct bath apparatus 10.

Bath apparatus 10 further includes a pump 50 disposed adjacent to bottom surface 14 of bath chamber 12 and in communication therewith. Pump 50 directs air into bath chamber 12 to generate air bubbles in the water contained therein. As shown in FIG. 4, pump 50 forces air through outlet tubes 52 which are connected to injection molded bubble egress strips or tubes 54 formed in communication with bath chamber bottom surface 14. Air is forced out of a plurality of egress holes 56 that are provided along each bubble egress tube 54 to form air bubbles B in the water contained in bath chamber 12, as illustrated in FIG. 3. Of course, outlet tube 52 and egress tube 54 could be constructed as a single component. In a preferred embodiment, one egress tube 54 is disposed within first side 19 of bottom surface 14, and the other egress tube 54 is disposed within the second side 21 of bottom surface 14. Alternatively, a single egress tube 54 could be constructed to extend between and generally traverse both first and second sides 19, 21.

In addition to the generally linear configuration of bubble egress tubes 54 depicted in FIGS. 2 and 4, bubble egress tubes 54 can be constructed to have various configurations which provide more complete coverage of bath chamber bottom surface 14. For example, bubble egress tubes 54 can have a continuous curvilinear configuration, including at least one generally S-shaped segment or at least one reverse curve, such as a serpentine configuration, as illustrated in the Ferber et al. U.S. Pat. No. 6,725,471 patent. Alternatively, bubble egress tubes 54 can have a generally U-shaped configuration, or can include a continuous configuration of linear segments, such as a square-wave or a sawtooth configuration, as illustrated in the Ferber et al. U.S. Pat. No. 6,725,471 patent.

With reference again to FIG. 2, bubble egress tubes 54 are disposed below bath chamber bottom surface 14, such that the plurality of egress holes 56 are flush with bottom surface 14. Alternatively, the bubble egress tubes 54 may protrude at least partially above bottom surface 14, such that egress holes 56 are raised above bottom surface 14. The plurality of bubble egress holes 56 can be positioned at multiple axial locations along the egress tube 54, thereby providing an even greater ability to generate bubbles within a given area of bottom surface 14.

Still further, bath apparatus 10 includes a vibration assembly 58 in communication with bath chamber 12 for imparting vibration to bath chamber 12 to provide a massaging effect to the feet. Vibration assembly 58 includes a motor 60 affixed to an underside of bath chamber 12, an output shaft 62 rotatably driven by motor 60, and a counterweight 64 affixed to output shaft 62. Vibration assembly 58 is affixed underneath a central portion of bath chamber 12 by a motor support bracket 66. When motor 60 is electrically powered, rotation of output shaft 62 and attached counterweight 64 imparts vibrations to motor support bracket 66, and these vibrations are then transferred to bath chamber 12 and the water contained therein in order to massage the feet. It is fully contemplated that variable vibration intensities could be provided in accordance with the present invention.

In further accordance with the present invention, bath apparatus 10 may include one or more interchangeable massage attachments adapted to be received on contact portion 20 for massaging the foot F upon engagement, such as the attachments disclosed in the Ferber et al. U.S. Pat. No. 6,725,471 patent. As with infrared heating member 46, massage attachments advantageously allow for massage to be targeted to specific locations of the foot such as the ball, heel, or arch. As best shown in FIGS. 1 and 2, a cap 82 is provided when the massage attachments are not in use.

Bath apparatus 10 includes a motor 83 disposed on an underside of bath chamber 12, and the massage attachments are adapted to be received on an output shaft that is rotatably driven by the motor 83 and adapted to be accessible through contact portion 20. Rotation of the output shaft causes the massage attachments to rotate, even when in contact with a user's foot F. Optionally, the motorized rotation of massage attachments can be activated by pressure of the foot F applied thereon, which then establishes electrical contact to supply power to motor 83. In this case, the operation of motor 83 is preferably not governed by selector 42, but rather power is supplied to motor 83 as long as bath apparatus 10 is plugged in.

As disclosed in the Ferber et al. U.S. Pat. No. 6,725,471 patent, the bottom surface 14 of the bath apparatus 10 may include detachable rollers provided thereon so that a user can glide his/her foot back and forth across rollers. The rollers help relieve tightness and tiredness along soles of feet, as well as for reflexology purposes.

With reference now to FIGS. 4-7, the pump 50 is described in greater detail. Specifically, the pump 50 is illustrated as an air fan assembly for forcing air into the egress tubes 54 and consequently through the egress holes 56 to provide a bubbling massage effect. Although the fan assembly 50 is illustrated and described, various fluid fans or pumps are contemplated within the spirit and scope of the invention. The fan assembly 50 includes a motor mount bracket 84 mounted to the housing 22. Specifically, the motor mount bracket 84 is mounted to the housing 22 through a pair of elastomeric pads 86. The elastomeric pads 86 absorb vibrations from the fan assembly 50 to reduce noise and vibrational harshness conveyed to the housing 22.

A motor 88 is mounted to one side of the motor mount bracket 84. The motor 88 includes a rotary output shaft 90, which extends through the motor mount bracket 84 and is driven by the motor 88.

An impeller 92 is mounted to the rotary output shaft 90 and is driven thereby. The impeller 92 includes a disc 94 having an array of toric impeller blades 96 provided thereon. The impeller blades 96 extend axially from the disc 94 in a direction away from the motor 88 and are inclined having a raised height radially inward relative to each blade. To maximize volumetric flow, a series of secondary impeller blades 98 are also provided alternating in length relative to the primary impeller blades 96 and disposed sequentially therebetween.

The fan 50 is a centrifugal fan and includes a volute shroud 100 collectively provided by the motor mount bracket 84 and a top shroud portion 102. Unlike prior art footbath blowers, the motor 88 is provided on an opposite side of the motor mount bracket 84 than the impeller 92. Thus, the shroud 100 is provided with an axial infeed port 104 rather than a plurality of radial infeed ports. The axial infeed port 104 is provided by a generally cylindrical sidewall 106 extending from the shroud 100, with an aperture 108 formed therein. The aperture 108 may be provided with a diverter 110 for assisting flow of air therearound and directly to the impeller blades 96, 98, thereby diverting air flow away from a hub 112 of the impeller. Thus, as air flows around the diverter 110, it is directed away from a dwell region provided at the hub 112 of the impeller 92.

The shroud 100 provides a single tangential outfeed port 114 for directing air out of the shroud 100. Referring to FIG. 6, the impeller blades 96, 98 each have a backward curve with respect to the direction of rotation, which is indicated by an arcuate arrow in FIG. 6. The impeller blades 96, 98 force air within the shroud 100 circumferentially within the shroud and subsequently out of the tangential outfeed port 114. The shroud 100 also includes a toric interior profile 116 generally corresponding with the profile of the impeller blades 96, 98 to provide efficient flow of air therethrough.

The centrifugal fan assembly 50 is much more efficient than prior art footbath blowers and is configured for efficient air flow of a generally consistent flow area through the path within the shroud 100 with a streamlined flow path to avoid turbulence, noise and vibrational harshness associated with prior art assemblies. For example, by eliminating radial infeed ports, a ninety degree change in flow direction is avoided at the inlet 104. By replacing a cylindrical shroud with a toric shroud, a constant flow area is provided so that the flow is not expanded and then contracted, which would otherwise cause turbulence and noise. Additionally, a single tangential outfeed port 114 is provided for consistent uninterrupted and even flow of air through the shroud 100.

Tubing 118 is mounted to the tangential outfeed port 114 in a direction of flow for providing uninterrupted flow from the shroud 100. A check valve 120 is provided downstream from the tubing 118. Although the invention contemplates providing a check valve on each of the outlet tubes 52, by providing a check valve 120 upstream of the outlet tubes 52, only one check valve 120 is required rather than two.

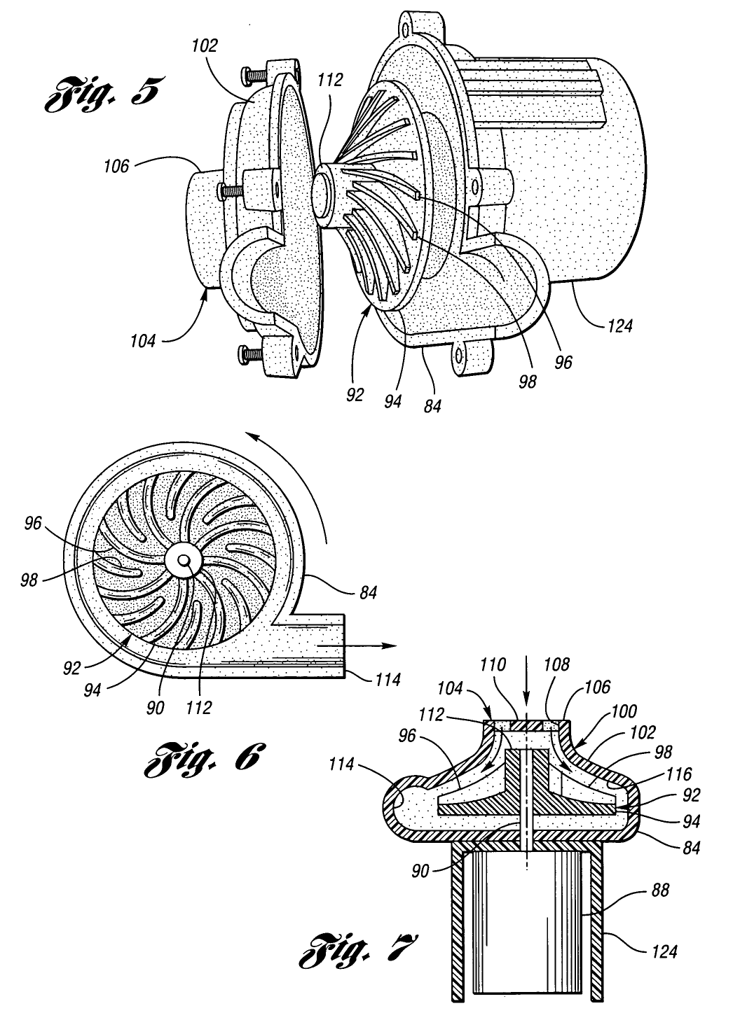

Further improvements to the bath apparatus 10 are provided for dampening sound associated with the fan 50. Downstream of the check valve 120 a Y-fitting 122 is provided. The Y-fitting assists directional flow from the tubing 118 to the outlet tubes 52, which are each mounted to the Y-fitting 122. The tubing 118, check valve 120, Y-fitting 122 and egress tubes 52 are each provided with clearance between each component and the housing 22 to avoid conveyance of vibrations from each of these components to the housing 22. Additionally, as illustrated in FIGS. 5 and 7, a motor shroud 124 is provided about the motor 88 to dampen acoustical vibrations conveyed from the motor 88.

The fan 50 provides a sound level output that is greatly reduced in comparison to prior art footbath fans. The fan 50 of the present invention provides a sound level output that is less than the sound level output provided from the bubbling massage effect in order to minimize output sound level without affecting the therapy effects of the bath apparatus.

Specifically, the bath apparatus 10 of the present invention has been subjected to the aforementioned sound level measurement conditions of the prior art footbaths. In an open room with a background sound level of forty-four decibels, at one meter away from the bath apparatus 10 in bubbling operation, an output sound level measurement of fifty-three decibels is measured. Thus, a sound level reduction of seven to eleven decibels is provided in comparison to the prior art. Accordingly, great noise reduction is provided by utilization of the fan assembly 50 of the present invention with a bath apparatus, such as the bath apparatus 10.

For sake of comparison, the bubbling massage effect of the bath apparatus 10 is compared with and without use of the fan assembly 50. Specifically, compressed air may be provided to the egress tubes 52 with a pressure corresponding to that provided by the fan assembly 50. The bubbling massage effect without the fan assembly 50 is measured as fifty-one decibels in an open room at one meter distance with the background sound level measurement of forty-four decibels.

Sound levels and decibels do not add numerically as linear figures. Doubling of power results in a three decibel increase in sound pressure. Since the sound level difference between the bath apparatus with the motor and bubbling massage effect and the bath apparatus with the bubbling massage effect only is less than three decibels, then the power has not been doubled. In other words, the output sound level of the fan assembly 50 only, without the bubbles must be less than the bubbles alone. Thus, an ideal sound level output is obtained by the present invention, because the fan assembly 50 is quieter than the bubbling massage effect. Therefore, the fan assembly 50 of the present invention does not detract from the therapeutic effects of the bath apparatus 10.

In summary, a bath apparatus 10 is provided with a substantially lessened output sound level in comparison to prior art footbaths. The bath apparatus 10 has a dampened sound level and desirous therapy effects optimizing both therapy and comfort to the user.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A footbath comprising:
a housing having a platform with sidewalls extending therefrom forming a bath chamber for retaining water, the bath chamber being sized to receive a body part within the sidewalls, the platform having a plurality of egress apertures formed therethrough; and
an air fan mounted to the housing in operable communication with the plurality of egress apertures for forcing air into the bath chamber through the egress apertures to provide a bubbling massage effect to the underside of the body part received in the bath chamber;
wherein a sound level measurement of the air fan in operation under defined testing conditions is less than a sound level measurement of the bubbling massage effect measured under the same defined testing conditions.

2. The footbath of claim 1 wherein a sound level measurement of the footbath in operation measured one meter from the footbath in an open room with a moderate background sound level is less than sixty decibels.

3. The footbath of claim 1 wherein a sound level measurement of the footbath in operation measured one meter from the footbath in an open room with a moderate background sound level is equal to fifty-three decibels.

4. The footbath of claim 1 wherein the fan further comprises:
a motor mount bracket mounted to the housing;
a motor mounted to the motor mount bracket, the motor having a rotary output shaft;
an impeller having a disc oriented generally perpendicular to and mounted upon the rotary output shaft, the impeller having a series of toric impeller blades extending axially from the disc; and
a volute shroud mounted to the motor mount bracket for enclosing the impeller therein, the shroud having an axial infeed port defined by a cylindrical sidewall extending axially from the shroud, and a tangential outfeed port in fluid communication with the plurality of egress apertures, so that rotation of the motor drives the impeller within the volute shroud for forcing air through the axial infeed port into the volute shroud, out of the shroud through the tangential outfeed port, to the egress apertures, and subsequently into the bath chamber to provide the bubbling massage effect.

5. The footbath of claim 4 wherein the motor is mounted on one side of the motor mount bracket, the rotary output shaft extends through the motor mount bracket, and the impeller is mounted to the rotary output shaft and oriented adjacent to another side of the motor mount bracket.

6. The footbath of claim 4 wherein the impeller blades extend axially from the disc in a direction away from the motor.

7. The footbath of claim 4 wherein the impeller blades are each inclined increasing in height radially inward.

8. The footbath of claim 4 wherein the shroud has a generally toric interior profile corresponding with the toric impeller blades.

9. The footbath of claim 4 wherein the series of impeller blades have alternating blade lengths.

10. The footbath of claim 4 wherein the series of impeller blades each have a backward curve relative to a direction of rotation of the impeller.

11. The footbath of claim 4 wherein the tangential outfeed port is further defined as a single tangential outfeed port that is connected to tubing for conveying the forced air to the bath chamber.

12. The footbath of claim 4 further comprising an elastomeric pad disposed between the housing and the motor mount bracket for dampening vibrations from the motor.

13. The footbath of claim 4 further comprising a motor shroud extending axially from the motor mount bracket for laterally enclosing the motor and dampening acoustical vibrations conveyed therefrom.

14. The footbath of claim 4 wherein the volute shroud is in fluid communication with the plurality of egress apertures via tubing that is isolated from direct contact with the housing along the length of the tubing to avoid translation of vibrations from the tubing to the housing.

15. A footbath comprising:
a housing having a platform with sidewalls extending therefrom forming a bath chamber for retaining water, the bath chamber being sized to receive a body part within the sidewalls, the platform having a plurality of egress apertures formed therethrough; and
an air fan mounted to the housing in operable communication with the plurality of egress apertures for forcing air into the bath chamber through the egress apertures to provide a bubbling massage effect to the underside of the body part received in the bath chamber;
wherein a sound level measurement of the footbath in operation measured one meter from the footbath in an open room with a moderate background sound level is less than sixty decibels.

16. The footbath of claim 15 wherein the sound level measurement is further defined as fifty-three decibels.

17. A footbath comprising:
a housing having a platform with sidewalls extending therefrom forming a bath chamber for retaining water, the bath chamber being sized to receive a body part on the platform within the sidewalls, the platform having a plurality of egress apertures formed therethrough; and
a fluid fan mounted to the housing in operable communication with the plurality of egress apertures for forcing a fluid into the bath chamber through the egress apertures, the fan having:
a motor mount bracket mounted to the housing,
a motor mounted to the motor mount bracket, the motor having a rotary output shaft,
an impeller having a disc oriented generally perpendicular to and mounted upon the rotary output shaft, the impeller having a series of toric impeller blades extending axially from the disc, and
a volute shroud mounted to the motor mount bracket for enclosing the impeller therein, the shroud having an axial infeed port defined by a cylindrical sidewall extending axially from the shroud, and a tangential outfeed port in fluid communication with the plurality of egress apertures, so that rotation of the motor drives the impeller within the volute shroud for forcing fluid through the axial infeed port into the volute shroud, out of the shroud through the tangential outfeed port, to the egress apertures, and subsequently into the bath chamber to provide a fluid massage effect to the underside of the body part received in the bath chamber.

18. The footbath of claim 17 wherein a sound level measurement of the fluid fan in operation under defined testing conditions is less than a sound level measurement of the fluid massage effect measured under the same defined testing conditions.

19. The footbath of claim 17 wherein the fluid fan is further defined as an air fan and the infeed port receives ambient air that is subsequently introduced into the bath chamber to provide a bubbling massage effect.

20. The footbath of claim 19 wherein a sound level measurement of the air fan in operation under defined testing conditions is less than a sound level measurement of the bubbling massage effect measured under the same defined testing conditions.
